(19) United States
(12) Patent Application Publication
(10) Pub. No.: US 2006/0266848 A1
(43) Pub. Date: Nov. 30, 2006

(54) Airbrush

(76) Inventor: Chung-Tsuen Juo, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/125,214

(22) Filed: May 10, 2005

(51) Int. Cl. B05B 7/30

(52) U.S. Cl. 239/346; 239/319; 239/353; 239/600; 239/379

(57) ABSTRACT

An airbrush including a hollow main body and a color barrel disposed on upper side of front section of the main body. The main body is formed with an internal longitudinal color passage. An air pressure intake pipe is disposed under middle section of the main body, in which an air pressure intake valve is mounted. A control button is arranged on upper side of the main body opposite to the air pressure intake pipe. The control button serves to drive an operation rod disposed in the main body for further driving a control needle disposed in the operation rod. A nozzle is screwed on front end of the main body. A front end of the control needle extends through the color passage and the nozzle. A cap is connected with a rear section of the main body for accommodating rear section of the operation rod. A linking structure is arranged between the cap and the operation rod, whereby the cap via the linking structure drives the operation rod to drive the control needle.

### BACKGROUND OF THE INVENTION

The present invention is related to an airbrush structure which is manufactured at lower cost and can be conveniently assembled. In addition, the airbrush has lower failure ratio.

FIG. 7 shows an existent airbrush structure including a hollow main body 6 and a color barrel 61 disposed on upper side of front section of the main body 6. The main body 6 is formed with an internal longitudinal color passage (not shown). An air pressure intake 62 is formed under the middle of the main body 6, in which an air pressure intake valve 63 is mounted. A control button 64 is arranged on upper side of the main body 6 opposite to the air pressure intake 62. The control button 64 serves to drive an operation rod 65 having a tightening sleeve 651. The operation rod 65 further drives a control needle 652 disposed in the operation rod 65. A collar 66 is screwed on front end of the main body 6. A nozzle 67 is screwed on front end of the main body 6 in front of the collar 66. A cap 7 is screwed on the rear section of the main body 6. Two sides of the cap 7 are respectively formed with two opposite windows 71. The tightening sleeve 651 of the operation rod 65 is exposed to outer side through the windows 71, whereby a user can adjust the control needle 652.

When ejecting the color, the control button 64 is rearward pulled and pressed down to open the air pressure intake valve 63. At-the same time, the control needle 652 is retreated, whereby by means of the sucking force generated by the air pressure, the color can be ejected from the nozzle 67.

After used, the user can rearward shift the tightening sleeve 651 with fingers to back and forth drive the control needle 652. Therefore, the color attaching to the control needle 652 and the nozzle 67 will not block the nozzle 67.

However, the above structure has some shortcomings as follows:
1. The manufacturing cost is higher. It is necessary to further process the cap to form the opposite windows. This leads to higher manufacturing cost.
2. It is inconvenient to use such airbrush. The cap has a fixed diameter so that the size of the windows is limited. As a result, it is hard to extend the fingers into the windows to retreat the tightening sleeve.
3. The windows are not clearly marked so that it is hard to truly locate the windows. When screwing the cap on the main body, the windows are often positioned on upper or lower side of the cap. As a result, a user can hardly conveniently use the airbrush.
4. The failure ratio is higher. Alien particles are likely to enter the main body through the windows of the cap to clog the internal parts. Therefore, the failure ratio is greatly increased.

### SUMMARY OF THE INVENTION

It is therefore a primary object of the present invention to provide an airbrush structure in which a first fixing section of a linking structure is formed on outer circumference of a tightening sleeve at rear end of the operation rod. A second fixing section of the linking structure is formed on inner circumference of a cap corresponding to the first fixing section. The cap via the linking structure drives the operation rod to drive the control needle. The second fixing section can be easily fixed with the first fixing section so that the airbrush can be conveniently assembled.

It is a further object of the present invention to provide the above airbrush structure in which the cap is free from any window so that the manufacturing cost is reduced.

It is still a further object of the present invention to provide the above injection pen structure in which the cap is free from any window so that alien particles can hardly enter the main body. Therefore, the failure ratio is greatly reduced.

According to the above objects, the airbrush of the present invention includes a hollow main body and a color barrel disposed on upper side of front section of the main body. The main body is formed with an internal longitudinal color passage. An air pressure intake pipe is disposed under middle section of the main body, in which an air pressure intake valve is mounted. A control button is arranged on upper side of the main body opposite to the air pressure intake pipe. The control button serves to drive an operation rod disposed in the main body for further driving a control needle disposed in the operation rod. A collar is screwed on front end of the main body and a nozzle is screwed on front end of the main body in front of the collar. A front end of the control needle extends through the color passage and the nozzle. A cap is connected with a rear section of the main body for accommodating rear section of the operation rod. A linking structure is arranged between the cap and the operation rod, whereby the cap via the linking structure drives the operation rod to drive the control needle.

The present invention can be best understood through the following description and accompanying drawings wherein:

### BRIEF DESCRIPTION OF THE DRAWINGS

FIG. 1 is a perspective exploded view of a first embodiment of the present invention;

FIG. 2 is a partially sectional assembled view of the first embodiment of present invention;

FIG. 3 is a partially sectional assembled view of the first embodiment of the present invention, showing the use thereof;

FIG. 4 is a perspective exploded view of a second embodiment of the present invention;

FIG. 5 is a partially sectional assembled view of the second embodiment of present invention;

FIG. 6 is a partially sectional assembled view of the second embodiment of the present invent-ion, showing the use thereof; and

FIG. 7 shows an existent airbrush.

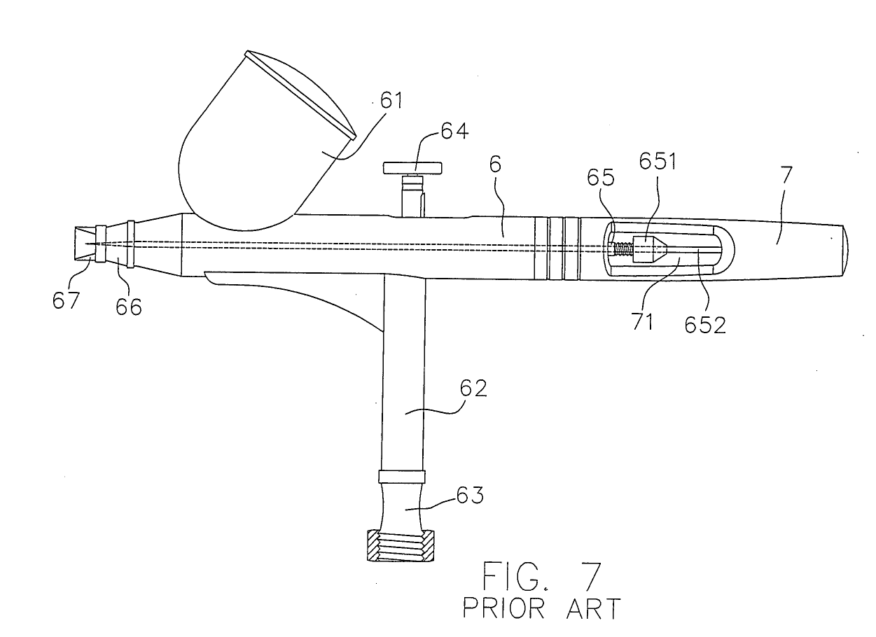

### DETAILED DESCRIPTION OF THE PREFERRED EMBODIMENTS

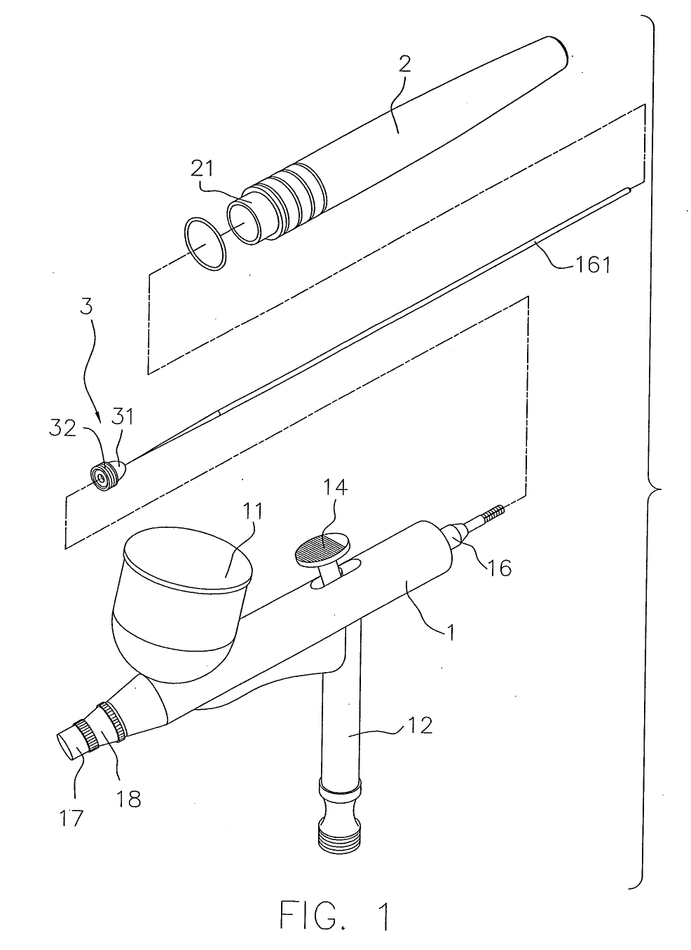

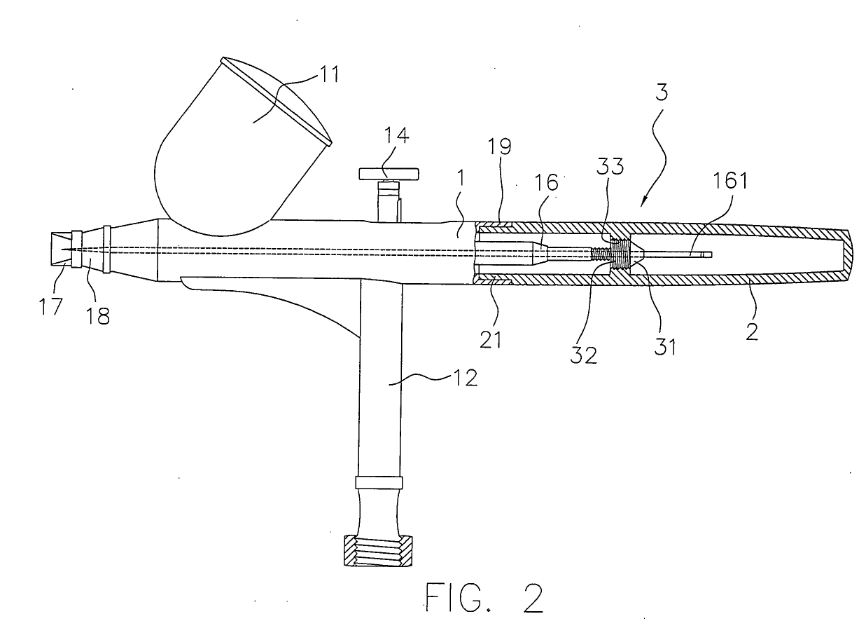

Please refer to FIG. 1 to 3. The airbrush of the present invention includes a hollow main body 1 and a color barrel 11 disposed on upper side of front section of the main body 1. The main body 1 is formed with an internal longitudinal color passage (not shown). An air pressure intake pipe 12 is disposed under the middle of the main body 1, in which an air pressure intake valve 13 is mounted. A control button 14 is arranged on upper side of the main body 1 opposite to the air pressure intake pipe 12. The control button 14 serves to drive an operation rod 16 disposed in the main body 1 to further drive a control needle 161 disposed in the operation rod 16. A collar 17 is screwed on front end of the main body 1. A nozzle 18 is screwed on front end of the main body 1 in front of the collar 17. A front end of the control needle 161 extends through the color passage and the nozzle 18. A cap 2 is connected with a rear section of the main body 1 for accommodating rear section of the operation rod 16.

A linking structure 3 is arranged between the cap 2 and the operation rod 16. The cap 2 via the linking structure 3 drives the operation rod 16 for driving the control needle 161. In this embodiment, the linking structure 3 includes a tightening sleeve 31 locked on rear section of the operation rod 16 for fixing the control needle 161. A first fixing section 32 is formed on outer circumference of the tightening sleeve 31. An inner circumference of the cap 2 is formed with a second fixing section 33 fixed with the first fixing section 32. In this embodiment, the first fixing section 32 is an outer thread formed on outer circumference of the tightening sleeve 31, while the second fixing section 33 is an inner thread formed on inner wall of the cap 2. The rear section of the main body 1 has a connecting section 19 and the cap 2 has a fitting section 21 corresponding to the connecting section 19. The connecting section 19 of the main body 1 is fitted with the fitting section 21 of the cap 2 so as to integrally connect the main body 1 with the cap 2. By means of the linking structure 3, the cap 2 is connected with the tightening sleeve 16. Accordingly, the cap 2 can drive the operation rod 16 to drive the control needle 161 and adjust the operation of the control needle 161.

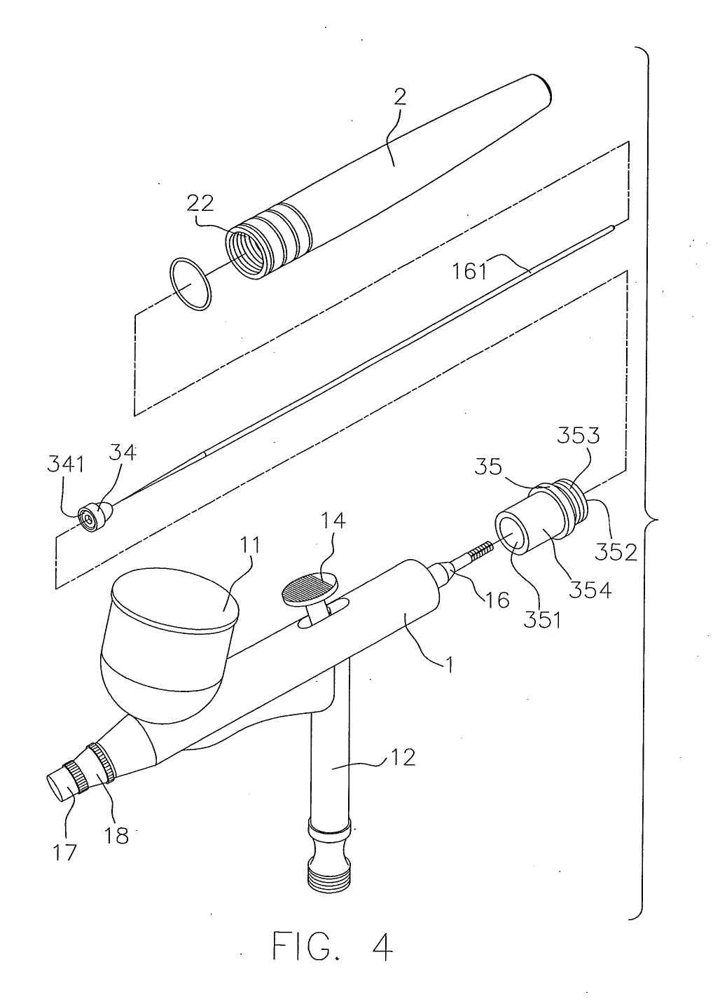

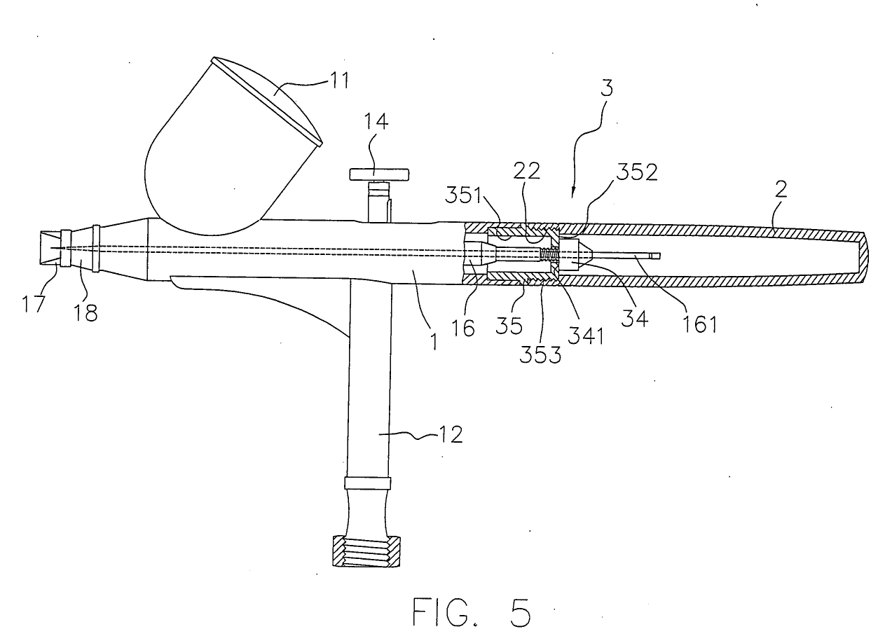

FIGS. 4 to 6 show a second embodiment of the present invention, in which the linking structure 3 includes a tightening sleeve 34 and a linking sleeve 35. The tightening sleeve 34 is locked on rear section of the operation rod 16 for fixing the control needle 161. One end of the tightening sleeve 34 has a first abutting face 341. The linking sleeve 35 has an internal passage 351. The rear section of the operation rod 16 extends into the passage 351. The linking sleeve 35 is positioned on one side of the first abutting face 341 of the tightening sleeve 34. One end of the linking sleeve 35 has a second abutting face 352 corresponding to the first abutting face 341 for abutting against the first abutting face 341. An outer circumference of the end of the linking sleeve 35 formed with the second abutting face 352 is formed with an outer thread 353. A slide section 354 is formed on outer circumference of the other end of the linking sleeve 35. The inner wall of one end of the cap 2 is formed with an inner thread 22 in which the outer thread 353 of the linking sleeve 35 is screwed. The rear section of the main body 1 is formed with a receiving space 13 in which the slide section 354 of the linking sleeve 35 is slidably fitted.

By means of the linking sleeve 35, the main body 1 is integrally connected with the cap 2. The cap 2 can drive the linking sleeve 35 to move. The second abutting face 352 of the linking sleeve 35 abuts against the first abutting face 341 of the tightening sleeve 34, whereby the tightening sleeve 34 is drivable by the linking sleeve 35. Accordingly, the cap 2 can drive the operation rod 16 to drive the control needle 161 and adjust the operation of the control needle 161.

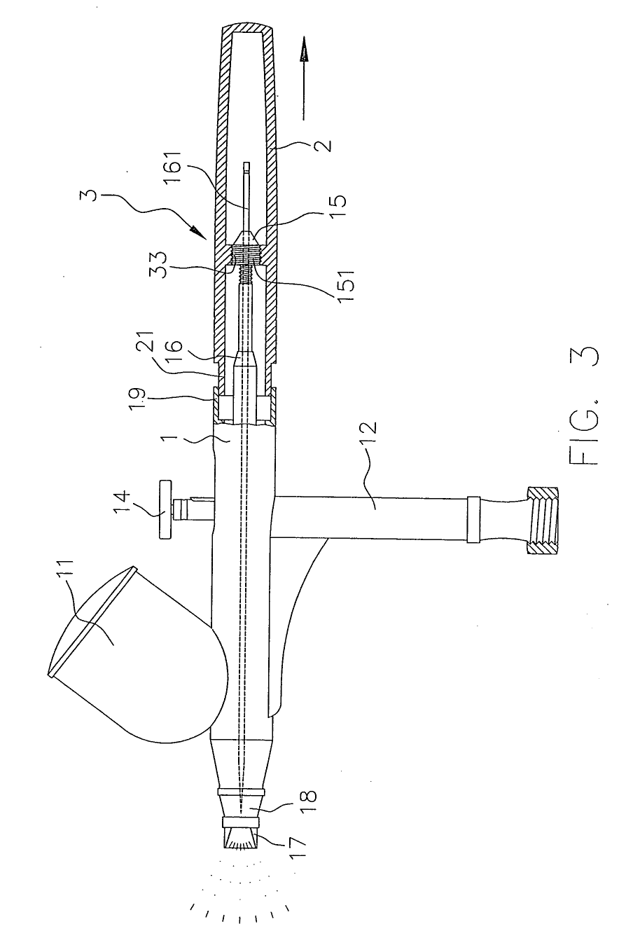

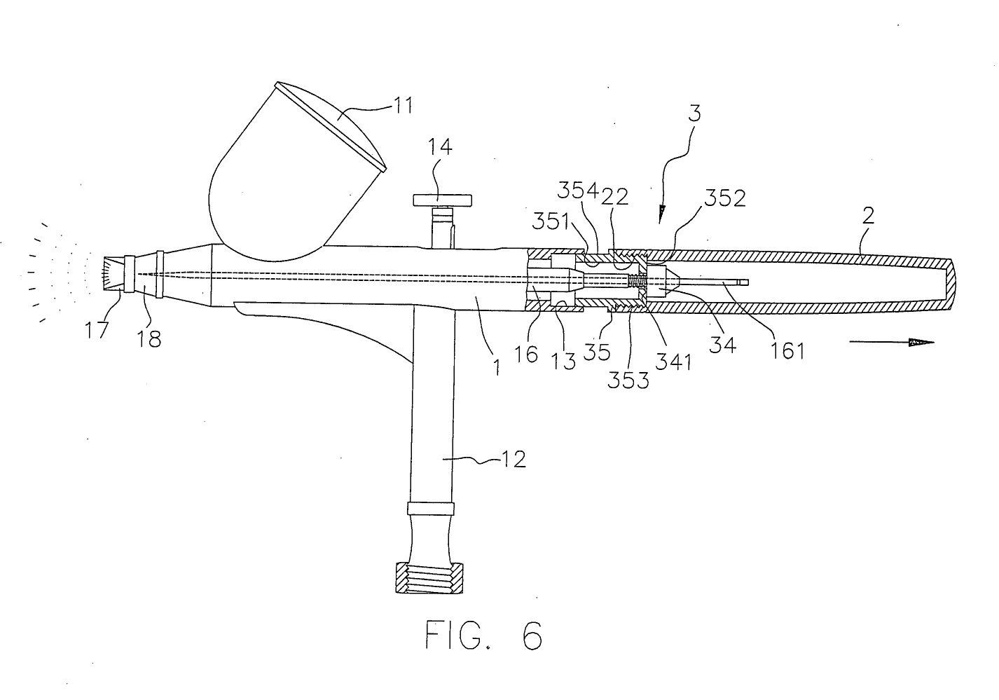

After used, a user can rearward shift the cap 2 as shown in FIGS. 3 and 6. The cap 2 via the linking structure 3 is drivingly connected with the operation rod 16. Therefore, the cap 2 will drive the operation rod 16 and further drive the control needle 161 to move back and forth. Therefore, the color attaching to the control needle 161 and the nozzle 18 will not block the nozzle 18.

According to the above arrangement, the present invention has the following advantages:
1. The manufacturing cost is lower. The cap is free from any window so that it is unnecessary to further process the cap in manufacturing procedure. Therefore, the manufacturing cost is reduced.
2. The airbrush can be conveniently used. The cap via the linking structure drives the operation rod. Therefore, when adjusting the control needle, a user only needs to rearward shift the cap. Therefore, the airbrush can be very conveniently used without considering the size of the user's fingers.
3. The failure ratio is lower. The cap is free from any window so that alien particles can hardly enter the main body. Therefore, the clog of the internal parts caused by the impurities can be avoided. Therefore, the failure ratio is greatly reduced.
4. The cap can be easily located. The connecting section of the main body can be fitted with the fitting section of the cap so as to integrally connect the main body with the cap.

Therefore, a user can conveniently locate the cap.

The above embodiments are only used to illustrate the present invention, not intended to limit the scope thereof. Many modifications of the above embodiments can be made without departing from the spirit of the present invention.

What is claimed is:

1. An airbrush comprising a hollow main body and a color barrel disposed on upper side of front section of the main body, the main body being formed with an internal longitudinal color passage, an air pressure intake pipe being disposed under middle section of the main body, in which an air pressure intake valve is mounted, a control button being arranged on upper side of the main body opposite to the air pressure intake pipe, the control button serving to drive an operation rod disposed in the main body for further driving a control needle disposed in the operation rod, a collar being screwed on front end of the main body, a nozzle being screwed on front end of the main body in front of the collar, a front end of the control needle extending through the color passage and the nozzle, a cap being connected with a rear section of the main body for accommodating rear section of the operation rod, a linking structure being arranged between the cap and the operation rod, whereby the cap via the linking structure drives the operation rod to drive the control needle.

2. The airbrush as claimed in claim 1, wherein the linking structure includes a tightening sleeve locked on rear section of the operation rod for fixing the control needle, a first fixing section being formed on outer circumference of the tightening sleeve, an inner circumference of the cap being formed with a second fixing section fixed with the first fixing section, the rear section of the main body having a connecting section and the cap having a fitting section corresponding to the connecting section, whereby the connecting section of the main body is fitted with the fitting section of the cap so as to integrally connect the main body with the cap.

3. The airbrush as claimed in claim 2, wherein the first fixing section is an outer thread formed on outer circumference of the tightening sleeve, while the second fixing section is an inner thread formed on inner wall of the cap, the outer thread being screwed in the inner thread.

4. The airbrush as claimed in claim 1, wherein the linking structure includes a tightening sleeve and a linking sleeve, the tightening sleeve being locked on rear section of the operation rod for fixing the control needle, one end of the tightening sleeve having a first abutting face, the linking sleeve having an internal passage, the rear section of the operation rod extending in the passage, the linking sleeve being positioned on one side of the first abutting face of the tightening sleeve, one end of the linking sleeve having a second abutting face corresponding to the first abutting face for abutting against the first abutting face, an outer circumference of the end of the linking sleeve formed with the second abutting face being formed with an outer thread, an inner wall of one end of the cap being formed with an inner thread in which the outer thread of the linking sleeve is screwed, the rear section of the main body being connected with the other end of the linking sleeve opposite to the second abutting face.

5. The airbrush as claimed in claim 4, wherein a slide section is formed on outer circumference of the other end of the linking sleeve opposite to the second abutting face, the rear section of the main body being formed with a receiving space in which the slide section of the linking sleeve is slidably fitted to integrally connect the main body with the cap.
